(19) United States
(12) Patent Application Publication
(10) Pub. No.: US 2008/0284573 A1
(43) Pub. Date: Nov. 20, 2008

(54) FACILITY STATUS INFORMATION NETWORKED SYSTEM

(75) Inventors: Robert W. Stambaugh, St. Petersburg Beach, FL (US); Thomas Boyer, St. Petersburg Beach, FL (US)

Correspondence Address: DENNIS G. LAPOINTE;LAPOINTE LAW GROUP, PL, PO BOX 1294, TARPON SPRINGS, FL, 34688-1294, US

(73) Assignee: RESTAURANT TECHNOLOGY CONCEPTS, INC., St. Petersburg Beach, FL (US)

(21) Appl. No.: 11/749,329

(22) Filed: May 16, 2007

(51) Int. Cl. G08B 1/00

(52) U.S. Cl. 340/286.02

(57) ABSTRACT

A facility status information networked control, communication and display system with one or more monitoring stations and wireless communication with a portable pagers. Each station displays a facility layout and has indicia representative of specific designated areas of a facility which is available for use. The indicia communicates to a staff member a status or a need in a designated area of said facility. The station has a touch screen and the indicia is illuminated. The system has a programmable circuitry. Each station and each pager are capable of for sending and receiving updated status changes corresponding to each specific designated area, sending page requests to other users within the system, and sending text messages to other users within the system. Statistical data can be remote collected and stored on a computer for analysis by a facility operator. The pagers can be programmed to operate in a desired mode.

### FIELD OF THE INVENTION

The invention relates to a table, room or other facility status change reporting system such as a restaurant table status system, a clinic or hospital room status system, or room hospitality status change system and similar facility status change systems, in particular, the invention relates to a networked system, including remote wireless pagers, for real time monitoring and controlling table or room usage and availability and communicating table or room status to and between key stations and staffers simultaneously.

### BACKGROUND OF THE INVENTION

Facility monitoring systems are known in the art, but most require various staffers, and especially the host or Maitre-D in the restaurant business or the reception desk personnel at a hotel or motel or the nurse or receptionist at a clinic, doctor's office or hospital, to either travel partially through the facility to personally observe the status of a table or room or to use the phone to verify the status of a room. In other cases, the person must communicate through head phones or a radio device with the floor staffers to verbally obtain information. This can be disruptive. A key staffer is generally very busy trying to keep track of incoming clients, numbers within the party, which server got the last table in a restaurant or which room was last assigned to a patient or customer in a hotel, etc. Having to stop and try to talk to staffers can disrupt a chain of thought. However, a monitoring board or screen where real time status can be observed at a glance will allow key personnel to more efficiently run the facility. So everybody does well, including the operators of the facility from the greater efficiency obtained with a real-time monitoring and control system.

### SUMMARY OF THE INVENTION

The present invention is an improvement to a system disclosed as a restaurant table turn control and display system for providing real-time communication to staff personnel throughout key areas of a restaurant in U.S. Pat. No. 6,980,088 issued to Stambaugh on Dec. 27, 2005, which is incorporated by reference herein in its entirety in lieu of repeating the disclosure herein. The present invention is further adapted for use in several types of facilities where status monitoring is of benefit to the operation of the facility. Such facilities can include room status monitoring in a clinic, a doctor's office, a hospital, an Inn, hotel or motel, where room availability/clean status needs to be monitored.

As an example of how a compatible system within the scope of the present invention may work in a restaurant facility, the following is presented. Keep in mind that should a clinic or hotel facility be used, a room status would apply instead of a table status and the staffers are called different names. First, the system and its mode of operation as described in U.S. Pat. No. 6,980,088 is herein incorporated by reference. Second, the present invention further comprises new features that include a pager and messaging product, which is a portable communication and status reporting system.

Accordingly, the system used in a restaurant would be comprised of a network of table turn table management monitors and portable pager units. The number or ratio of fixed table turn panels to portable pagers is determined by the application of the product and can be deployed in any number or combination including a system where there are no fixed monitors (portable units only) in the system.

Main functions of the system include:
Monitoring and updating table status (empty, occupied, needs busing);
Sending page requests to other users within the network (for example, “I need you”, or “go to a location”); and
Sending text message instructions to other users within the network.
   Text messages may be a pre-programmed selection set of messages or instructions or input as open text. Selecting a message to send can be achieved by inputting a number associated with the message or by scrolling through a selection list. The system can be programmed to send messages in languages other than the language of the inputted text so a message inputted in English can be read by a receiver in Spanish or vice-versa.

The following is by way of example only of desired typical features and modes of operation of the present invention in a restaurant facility. One can easily see the inherent application of the system to a room status type of operation.

1. Features:
a. Pager is Active: When a portable unit is activated in the network a status lamp associated with that device on the fixed monitors illuminate. This visually notifies users which pager units are active in the system. When a pager unit is powered down or leaves the range of the network, the indicating lamp turns off.
b. Setup Options:
   i. Pager Number: The pager number or pager ID is selectable in the setup menu. In the event a pager becomes lost or inoperable, any other pager can be set to operate like the missing unit.
   ii. Mode: Pager Mode is selected for the specific user based on their position and specific duties in the workgroup network (i.e. manager, bus person, bartender, hostess or wait-staff).
   iii. Sound ON/OFF: Audio alert can be turned on or the unit will alert with vibrate only.
   iv. Language: Pager units can be set to alternate languages. Pager messages can be sent in English and messages received in the alternate language.

c. Battery: Pager unit battery is preferably rechargeable. Battery may be removed and recharged or recharged in the pager unit with a supplied power cord assembly. Calculated usage time before recharge is ideally 10 or more continuous hours.
d. Water resistant.
e. May be worn as an armband with hook-and-loop straps (for example, straps made by the Velcro® Corporation), belt clip or be mounted for wall/table-top use.

2 Modes:
a. Bus Staff Mode:
   i. Unit can send and receive page requests to/from other users in the network.
   ii. Unit can send and receive messages to/from other users in the network.
      1. Preferably, only messages from “Bus Staff Message Set” can be sent from a pager in Bus Staff Mode.
   iii. Page Acknowledge:
      1. Pager will continue to alert the receiving unit until the receiver acknowledges the page by pressing “OK”. The sender receives confirmation message indicating page was received.
      2. If page is not acknowledged after a programmed time has expired on page attempts, page is discontinued and sender receives message indicating the page was not received.
   iv. Unit continuously scans the Table Turn network and displays table numbers that are flashing (needs bussing) or blinking (needs bussing—over six minutes).
      1. Table numbers that have been in flashing/blinking state for the longest time appear first on the bussing list.
      2. Table numbers that are in the blinking state flash on the pager display.
      3. If the list of tables that need bussing is longer than 1 line (16 characters) the line will scroll the complete list.
   v. The network status of a table can only be updated to “table available”. Note: It is preferable that a Buss Staff pager cannot update a table to “needs bussing” or “occupied” state.
   vi. When restroom alert is activated manually or by an automatic timer on the Table Turn system, a message is automatically delivered to all Bus Mode Pagers of the alert.
b. Manager Mode:
   i. Unit can send and receive page requests to/from other users in the network.
   ii. Unit can send and receive messages to/from other users in the network.
      1. Only messages from “Manager Message Set” can be sent from a pager in Manager Mode.
   iii. Continuous display of tables that require bussing can be toggled on or off.
   iv. The network status of a table can be updated to the next process state. For example, a table that shows “available” on the table Turn network can be updated to “occupied”, a table that shows “occupied” can be updated to “needs bussing” and a table that appears “needs bussing” can be cleared to “available”,
c. Bartender Mode:
   i. Unit can send and receive page requests to/from other users in the network.
   ii. Unit can send and receive messages to/from other users in the network.
      1. Only messages from “Bartender Message Set” can be sent from a pager in Bartender Mode.
      iii. Continuous display of tables that require bussing can be toggled on or off.
      iv. The network status of a table can be updated to the next process state. For example, a table that shows “available” on the table Turn network can be updated to “occupied”, a table that shows “occupied” can be updated to “needs bussing” and a table that appears “needs bussing” can be cleared to “available”.
      v. One can easily ascertain from the above how the invention would operate in other modes such as a Hostess Mode or Sever Mode.

3. Other:
a. All messages are designated to a user group (or mode).
   i. If a message is selected and sent to no specific user, the message will be delivered to all pagers operating in the mode designated for that message.
      1. For example if the message “SWEEP ENTRY” is sent but no specific user is selected to receive, all users in Bus Staff Mode will receive the message. “SWEEP ENTRY” would be designated as a Bus Staff message so only those pagers would receive the message.

4. Table Turn Functions for Pagers:
a. Table Turn Stations can send and receive page requests to portable units in the network.
b. Table Turn units can send and receive messages from other users in the users in the network.
c. Electroluminescence (EL) technology to backlighting method may be used in addition to other lighting technology described in U.S. Pat. No. 6,980,088.

### Network Data Flow and Manipulation:

As can be assimilated from the above, the system communicates within itself to each of the individual modules (monitors or portable devices or pagers) by utilizing a peer-to-peer type network. That is, any module will broadcast a communication transmission to all of the members in the network and each of the receiving modules will act on the transmitted event. Examples of a unit's action upon receiving a transmission are: display a text message on the LCD screen, buzz or vibrate the unit to alert the user, or ignore the transmission (communication is not relevant to this module). Advantages to using this peer-to-peer type communication network is that there is no master controller unit. Members within a network can be added or removed during operation without interrupting the session of effecting active communication transmissions.

### Data Collection Feature:

The present invention can be programmed to collect statistical data about the activity within the Table Turn system or other facility system. For a restaurant, the information could include the time between seatings, the table occupancy for any given time, the number of seatings over a given time, the length of time patrons remain at their tables and how frequently tables go into “Code III” (table needs bussing has exceeded six minutes), etc. The data can be collected as an average for the entire restaurant, a given set of tables within the restaurant or even individual tables. For a clinic, the information could include time between uses, the room use/occupancy for any given time, the number of uses/occupancies over a given period of time, the length of time a patient or client occupies the room or how frequently a room turns over, etc.

The method for collecting this data is achieved by monitoring the wireless data traffic throughout the system. The data, once collected is stored on devices within the system. A separate device may be employed or the data collection or the feature may be integrated into components within the system. The frequency of data transfer from the system to the user's computer system is defined by the user. It may be downloaded continuously, at set time intervals or only on user command.

Stored data could be downloaded from the system memory into computers or computer systems. The data could be compiled into spreadsheet form where it can be manipulated by the user for analysis. Data distribution from the system can also include password protected publication on the internet for authorized users to access from any internet connected device from any location in the world. When data is continuously downloaded from the Table Turn system onto an internet website, the web page can display, in real time, the current status of a restaurant's activity.

Backlighting with Electroluminescence Technology

Table or room locations (cells) can be illuminated with electroluminescence (EL) technology in addition to the LED lamp method as indicated in the above-mentioned patent to Stambaugh.

### Background Information on EL Technology:

Electroluminescent panels are frequently used as backlights to liquid crystal displays. They readily provide a gentle, even illumination to the entire display while consuming relatively little electric power. This makes them convenient for battery-operated devices such as pagers, wristwatches, and computer-controlled thermostats and their gentle green-cyan glow is a common sight in the technological world. They do, however, require relatively high voltage. For battery-operated devices, this voltage must be generated by a converter circuit within the device; this converter often makes an audible whine or siren sound while the backlight is activated. For line-voltage operated devices, it may be supplied directly from the power line. Electroluminescent nightlights operate in this fashion.

In either case, the EL material must be enclosed between two electrodes and at least one electrode must be transparent to allow the escape of the produced light. Glass coated with indium oxide or tin oxide is commonly used as the front (transparent) electrode while the back electrode is or is coated with reflective metal. Additionally, other transparent conducting materials, such as carbon nanotubes coatings or PEDOT can be used as the front electrode.

Unlike neon and fluorescent lamps, EL lamps are not negative resistance devices so no extra circuitry is needed to regulate the amount of current flowing through them.

In principle, EL lamps can be made in any color but the greenish color most commonly used matches well with the peak sensitivity of human vision so it produces the greatest apparent light output for the least electrical power input.

EL devices have low power consumption when compared with neon signs, and have a wide range of applications such as their use on advertising boards and safety signs. Because an EL layer can be very thin (around 1 mm thick), it can be used as decoration added to everyday items, including clothing and accessories such as bags and earphone cords.

The features and operational characteristic of the station monitors, except as additional features and operational characteristics are herein described above, are also described in U.S. Pat. No. 6,980,088 to Stambaugh and herein incorporated by reference.

### BRIEF DESCRIPTION OF THE DRAWINGS

In the accompanying drawings:

FIG. 1 is a conceptual depiction of a system network and the communication between its members;

FIG. 2A is a perspective depiction of a typical pager unit;

FIG. 2B is an exploded view of the pager unit of FIG. 2A showing the primary components of the pager unit and their physical relation in an assembled module;

FIG. 2C is a depiction of one example of the use or wearing of the pager unit where an arm strap is used to secure the unit to a person's arm;

FIG. 3 is a block diagram depicting the active components (enclosure and hardware not shown) in the pager unit and how they relate to each other;

FIG. 4A is a typical example of a floor plan arrangement on a station being used in a restaurant;

FIG. 4B is a typical example of a floor plan arrangement on a station being used in an office environment such as a doctor's clinic;

FIG. 5A is a conceptual flow chart of touch screen monitors at various restaurant stations with the communicative interrelationship of the bus boy signal caller;

FIG. 5B is a conceptual flow chart of an example of the communicative inter-relationship between the hostess screen monitor or station and the manager's signal caller;

FIG. 5C depicts a conceptual flow chart of examples of the communicative inter-relationship between the kitchen screen monitor or station and the manager's signal caller as well as a side station touch screen monitor or station and the manager's signal caller;

FIG. 5D depicts a conceptual flow chart of an example of communication between the manager's signal caller and the bus boy signal caller; and

FIG. 5E depicts a conceptual flow chart of an example of communication between the bartender's signal caller and the manager's signal caller.

### DETAILED DESCRIPTION OF THE INVENTION

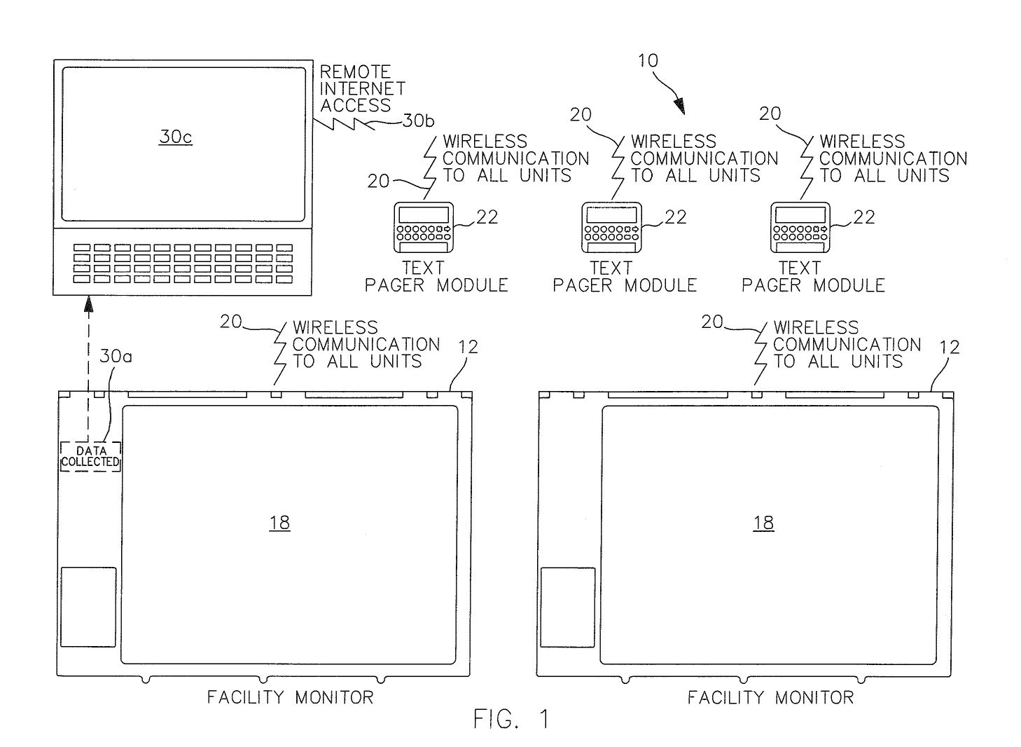

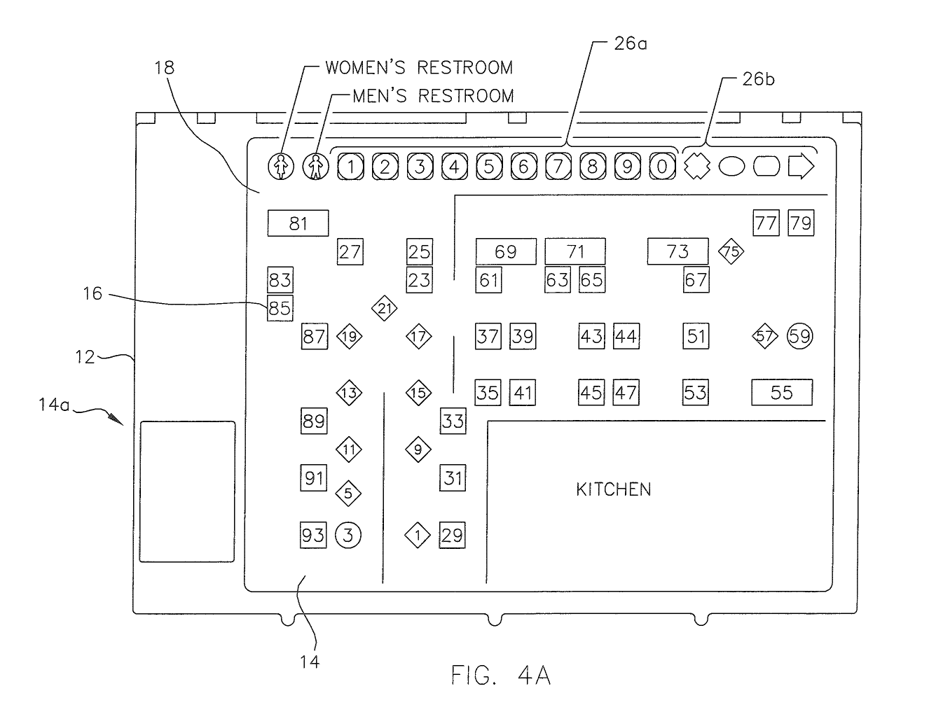

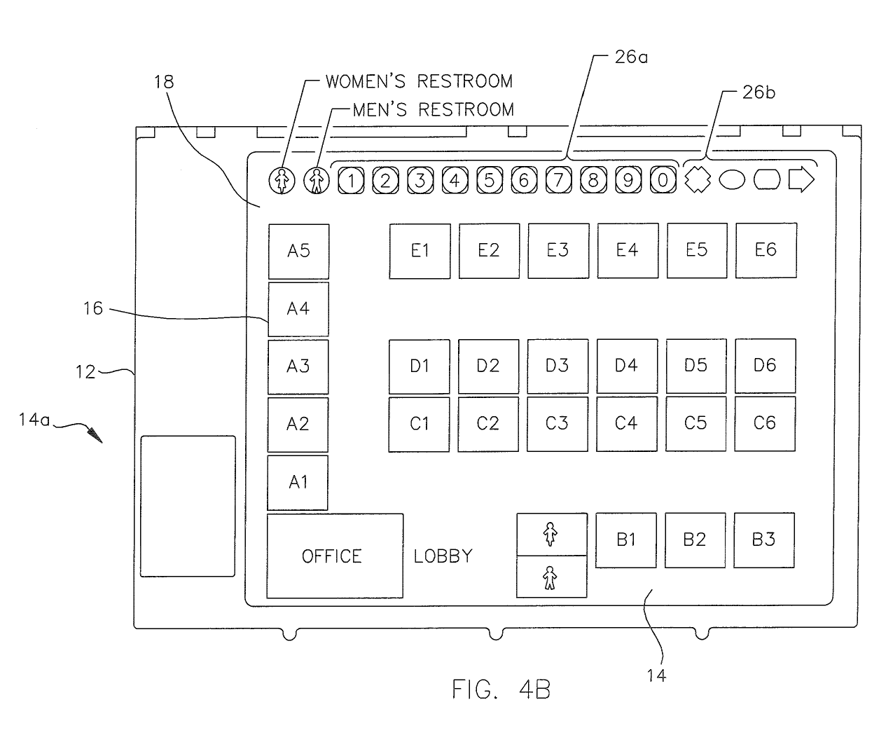

Referring to FIG. 1, the invention is a facility status information networked control, communication and display system 10 that includes one or more monitoring stations 12. Each station 12 is configured and adapted to display a facility layout 14, examples of which are depicted in FIG. 4A for a restaurant type of facility and FIG. 4B for a facility where rooms or gaming stations or other areas are desired to be monitored.

Each station 12 has indicia 16, which are representative of specific designated areas of the facility available for use. The indicia 16 further serves as means for communicating to a staff member a status or a need in a designated area of said facility.

It is preferable that the station 12 have a touch screen 18 for activating desired status changes on the system, as well as the ability to illuminate the selected indicia 16 as described herein above and in U.S. Pat. No 6,980,088 to Stambaugh. As described in that patent, the system 10 is programmed to provide status changes and communicating such status changes simultaneously to each station 12, which is electrically and operatively connected to the stations 12 or is in wireless electronic communication with the stations 12. An example of circuitry that would operate the system 12 is found in FIGS. 9A-9B of U.S. Pat. No. 6,980,088 to Stambaugh, which represent an electrical schematic of one example of how to assemble the circuitry to operate a system using a basic touch screen, LED technology and a restaurant overlay.

One preferred embodiment however is that each station be able to communicate with each other by wireless electronic communication transmissions 20 as well as to communicate similarly between a plurality of portable pagers 22 and the stations 12.

The stations 12 and the portable pagers 22 each having means for sending and receiving updated status changes corresponding to specific designated areas, sending page requests to other users within the system 10, and sending text messages to other users within the system 10.

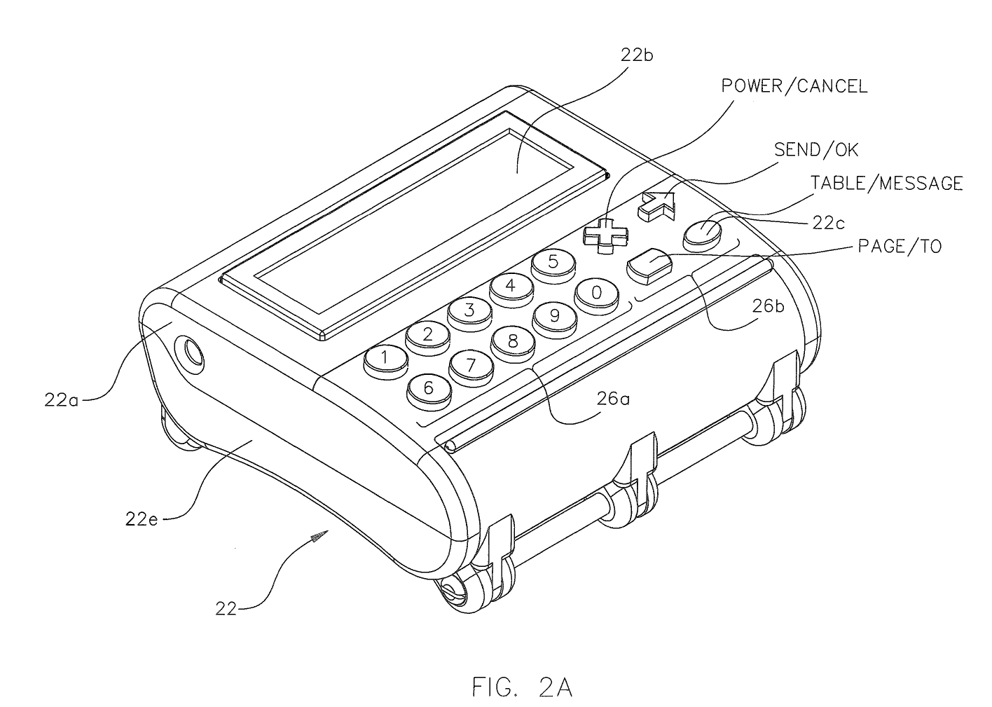

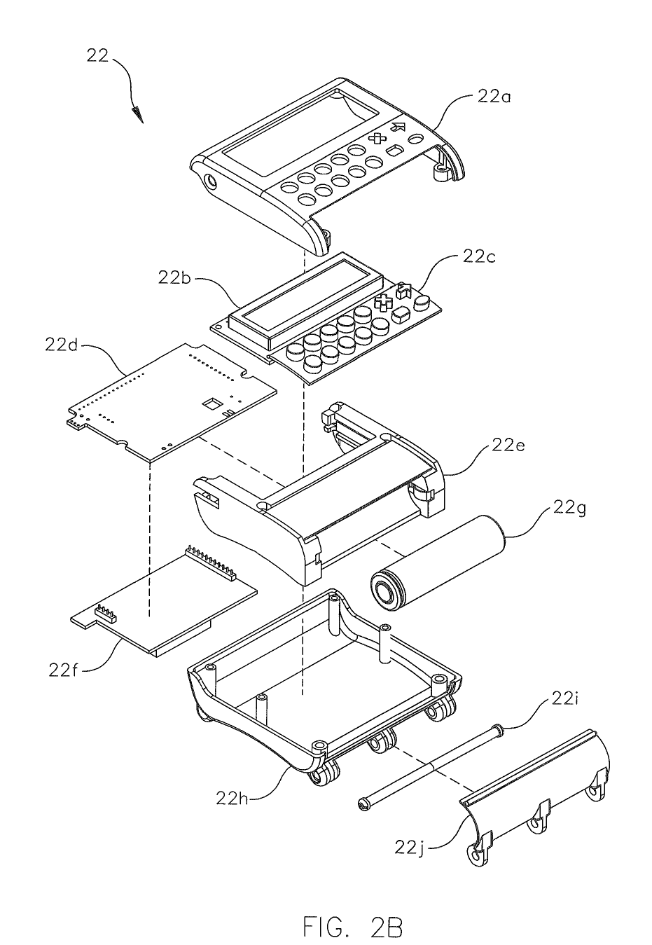

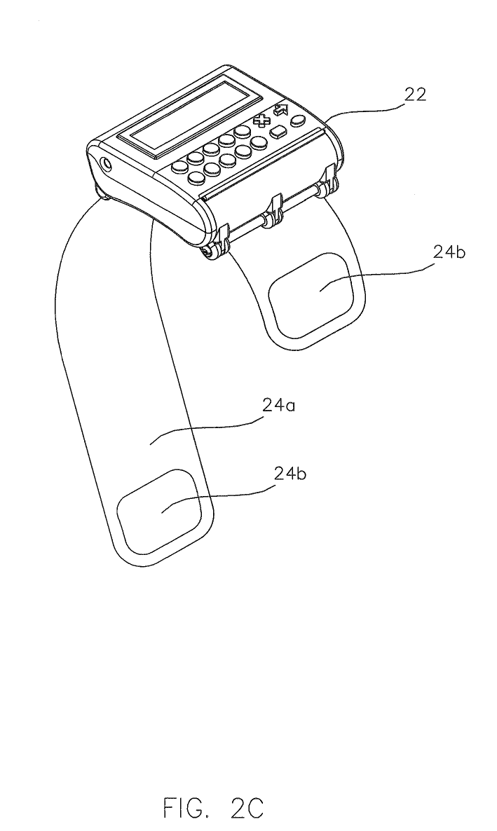

FIGS. 2A-2C depict one example of what a pager unit 22 might look like. Components are depicted in the FIG. 2B exploded view. As shown, an arrangement of depicted components are: enclosure top 22a, LCD display 22b, membrane keypad 22c, controller PCB 22d, enclosure liner 22e, data transceiver 22f, battery 22g, enclosure bottom 22h, hinge pin 22i, and battery door 22j. In FIG. 2C, an example is provided on how the portable pager 22 may be worn by a user. In this example, the pager 22 is attached to a strap 24a, which can be wrapped around a limb such as a wrist or arm or even a thigh of the user. The strap 22a in this example is attached to the limb using mating hook and loop fastener means 24b. Other attachment means are contemplated and not shown such as a clip to attach to a person's belt, or a hook or clip to attach to a nearby work station wall.

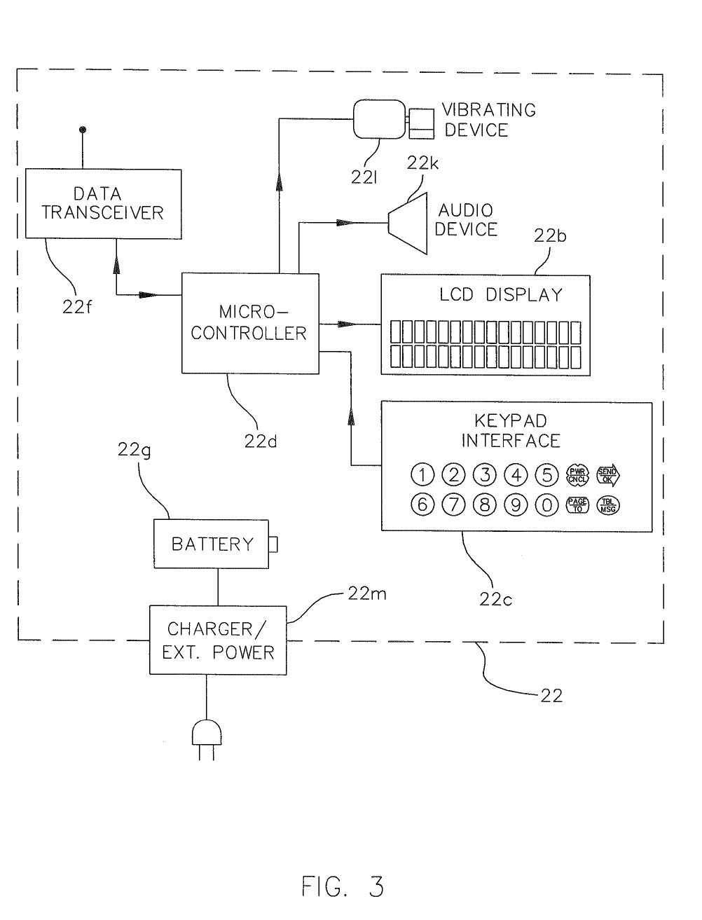

FIG. 3 is a block diagram depicting the active components (enclosure and hardware not shown) in the pager unit 22 and how they relate to each other. It is preferred that the battery 22g be capable of being recharged is external power through a charger 22m. Other optional components are an audio device 22k and a vibrating device 22l to be integrated with the pager unit 22.

FIG. 4A is a typical example of a floor plan arrangement on a station 12 being used in a restaurant, while FIG. 4B is a typical example of a floor plan arrangement on a station 12 being used in an office environment such as a doctor's clinic. As can be seen, the designated areas in these drawings can be substituted with casino gaming tables or gaming areas or sections, or room such as hotel rooms, etc. The application and use can be adapted to almost any environment where status changes and communications will improve the efficiency and operations of a facility. In the examples depicted, the pager buttons 26a and pager control buttons 26b are shown.

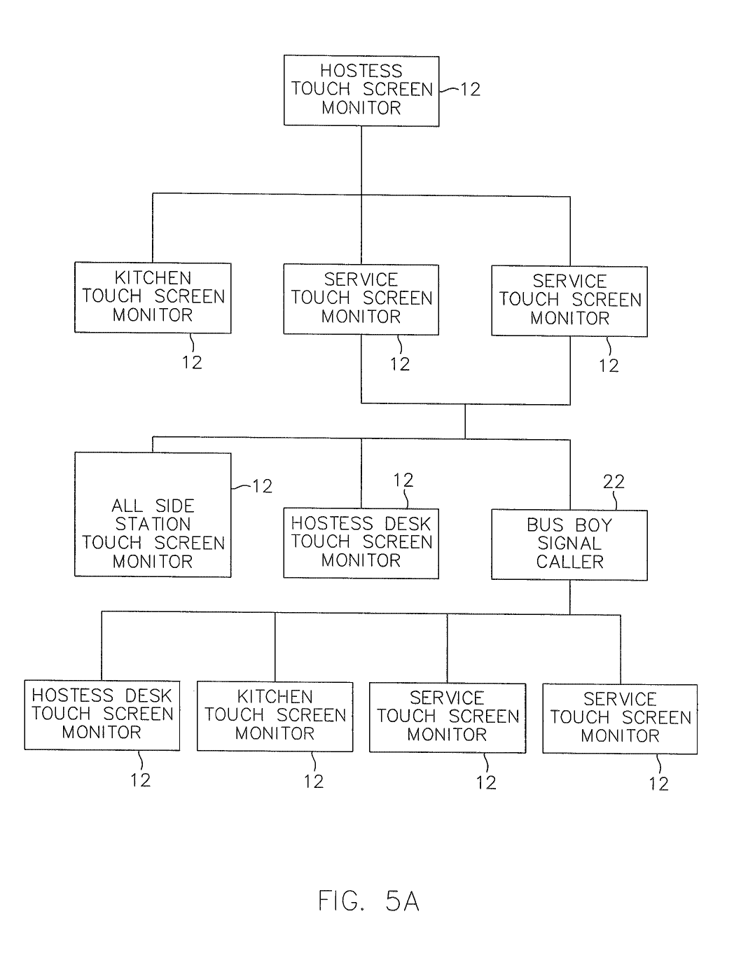

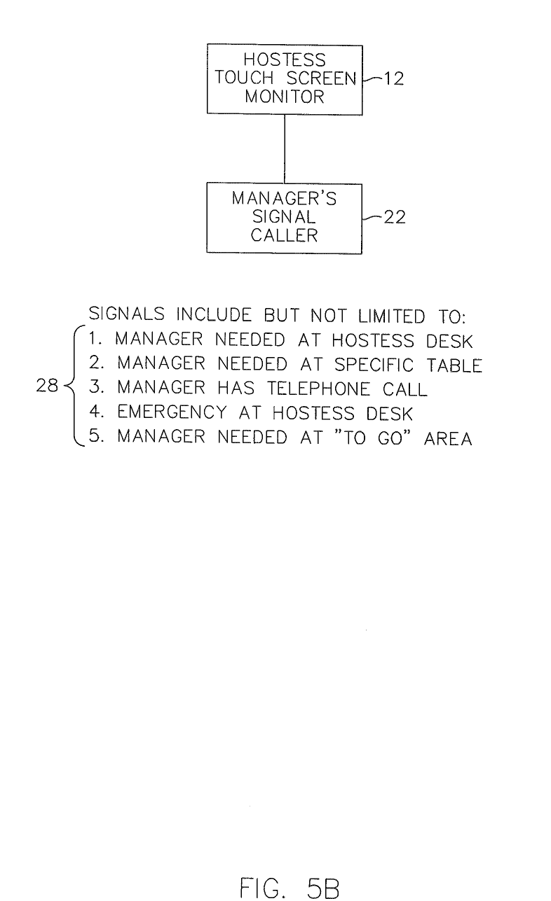

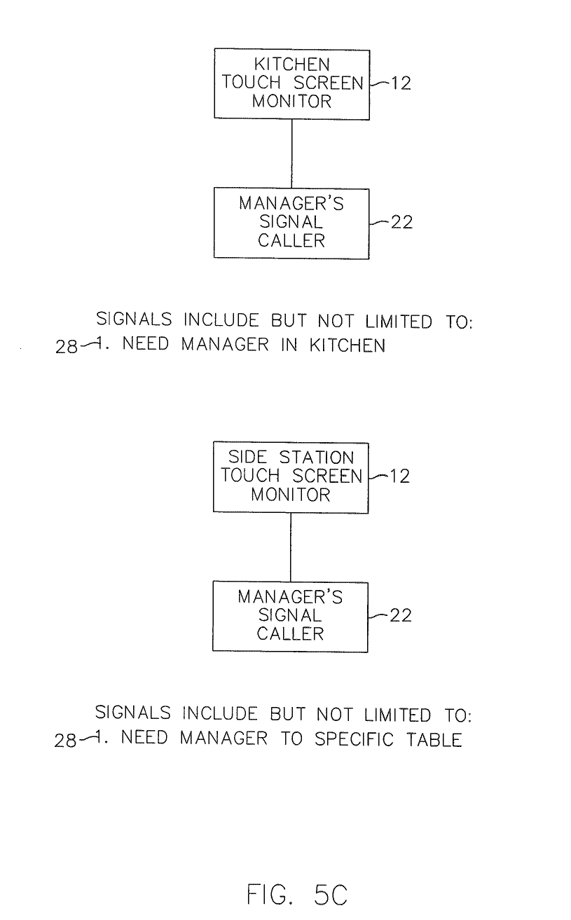

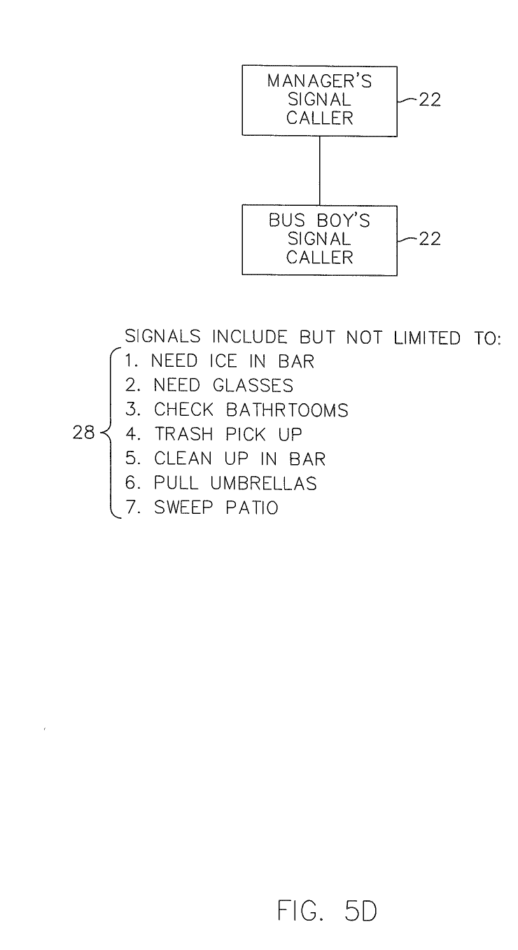

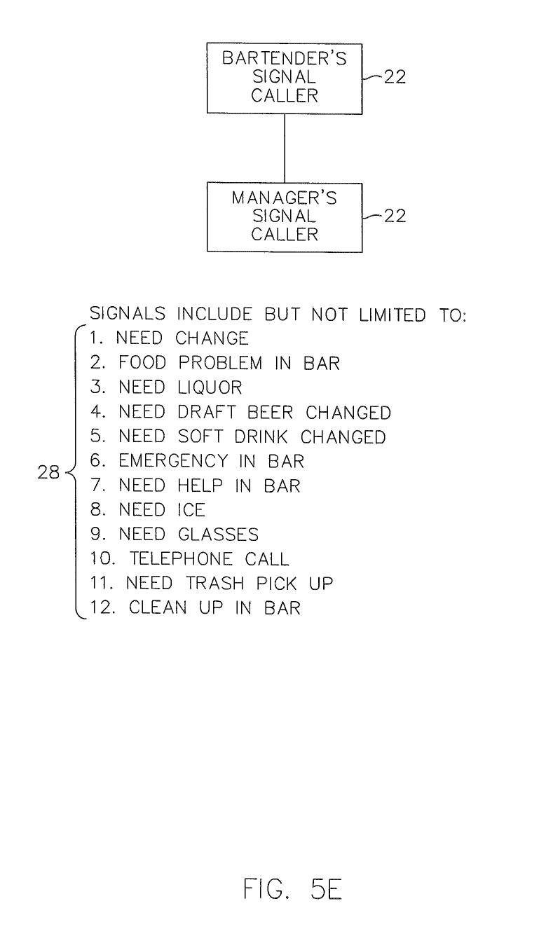

FIG. 5A is a conceptual flow chart of the touch screen monitors at various restaurant stations with the communicative interrelationship of the bus boy signal caller as it applies to a restaurant operation. Side, service, kitchen, hostess stations are depicted in relation to the busboy signal caller pager 22. FIG. 5B is a conceptual flow chart of an example of the communicative inter-relationship between a hostess screen monitor or station 12 and the manager's signal caller pager 22, with examples of signals or text messages 28 that can be communicated. FIG. 5C depicts a conceptual flow chart of examples of the communicative inter-relationship between the kitchen screen monitor or station 12 and the manager's signal caller pager 22 as well as a side station touch screen monitor or station 12 and the manager's signal caller pager 22, again with typical messages or text 28 that might be communicated. FIG. 5D depicts a conceptual flow chart of an example of communication between the manager's signal caller pager 22 and the bus boy signal caller 22, again with typical messages or text 28 that might be communicated between the pagers 22. FIG. 5E depicts a conceptual flow chart of an example of communication between a bartender's signal caller pager 22 and a manager's signal caller pager 22, again with typical messages or text 28 that might be communicated.

The system 10 preferably also is configured and adapted to provide for means for collecting statistical data related to a desired activity within a facility 14a. As discussed above data can be collected and stored on a drive 30a and be remotely accessed by wireless means 30b to a remote computer 30c.

The system pagers 22 can be programmed to pre-select a desired pager 22 to operate in a predetermined mode so as to communicate between a limited number of personnel in the facility 14a.

As with the illumination means for the stations 12, provisions are made for preferably including backlighting means for the display screen 22b on each portable pager 22.

As depicted in the FIG. 3 example, the keypad typically has 14 buttons that control the functions of the pager unit 22. Examples of typical functions are:

Numeric Keys 1 through 9 and 0—These keys are used to input a number string. Other pager units, locations within a facility and text messages are assigned number identifiers. To perform a function that includes another pager, a facility location or a text message the number identifier will be entered.

PWR/CNCL (Power/Cancel)—This button is used to power the unit on or off or also to cancel a command if an error is made. When the unit is off, pressing the PWR/CNCL button will power up the pager. Pressing the PWR/CNCL button momentarily will cancel any current activity. Pressing and holding the power button for 4 seconds will power down the pager.

SEND/OK—This button is used to complete a communication. After an action is defined (paging, messaging or updating facility monitor status) the SEND/OK key instructs the pager module to complete the action When a page or instruction is received from another pager, the user will also press the SEND/OK button to send back a “I have received the page” confirmation message. The sending pager will continue to alert the action until a confirmation response is received or a timer has expired.

PAGE/TO—This button is used to initiate the action of sending a page to another user. After the page function is activated and the receiving pager defined (by entering the number identifier of the receiving pager) the PAGE/TO button is again used to instruct the receiver to report to a location (enter the location number identifier).

TBL/MSG (Table/Message)—This button is used to initiate a status change in the facility monitor. It is also used after the page function is activated to send the receiving user to a location.

### EXAMPLES

Assume the following is entered on the keyboard. “PAGE”, “7”, “TO”, “57”, “SEND”—This input string will PAGE unit number 7 and instruct them report to table 57. The user holding pager 7 should respond by pressing OK.

Assume the following is entered on the keyboard. “TBL,”, “57”, “SEND”—This input string will change a table status on the facility monitor from blinking (needs bussing) to off (available for seating).

Assume the following is entered on the keyboard. “PAGE”, “7”, “MSG”, “4”, “SEND”—This input string will deliver a preset (message number 4) message to unit 7. The user holding pager 7 should respond by pressing OK. As a convenience feature, the last message sent will automatically display when the sender selects the MSG key. If that is the message desired, he could just hit SEND. If the user does not remember the number identifier for a message he can continue to hit the MSG key and it will scroll the available messages, SEND when the desired message is displayed.

The predefined messages are also assigned to be associated with unit modes. For example a message that instructs a user to “CLEAN KITCHEN EQUIPMENT” would be associated with users in the BUSSER MODE. A manager can send that message but not define the receiver. The system would automatically deliver that message to all units in BUSSER mode.

Although the above description related to the keyboard usage is directed at a restaurant type of operation, one can easily see how the titles of positions and designations might change to adapt the system to other facilities. For example, instead of a “table”, a “room” could be used to designate an office room, a clinic room or a hotel/inn room. The “hostess” might be called the “front desk” or “receptionist”. Other possible adaptations are in the following industries: casinos, medical facilities, beauty shops and beauty shop training facilities and essentially any and all businesses that require information to be transmitted or communicated from one area of the business to another.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A facility status information networked control, communication and display system comprising:
one or more monitoring stations, each station comprising means for displaying a facility layout;
each station having indicia, the indicia being representative of specific designated areas of the facility available for use, said indicia further being for communicating to a staff member a status or a need in said designated area of said facility;
touch screen means for activating desired status changes on the system;
means for illuminating the selected indicia;
programmable circuitry means for operating and controlling the system, including providing status changes and communicating such status changes simultaneously to said stations electrically and operatively connected to said stations or in wireless electronic communication with said stations, said programmable circuit means further comprising wireless electronic communication means for communicating between said stations and a plurality of portable pagers;
said plurality of portable pagers having electronic wireless means for communicating between said stations and said pagers; and
said stations and said portable pagers each having means for sending and receiving updated status changes corresponding to said specific designated areas, sending page requests to other users within said system, and sending text messages to other users within the system.

2. The system according to claim 1, further comprising:
means for collecting statistical data related to a desired activity within said facility.

3. The system according to claim 1, further comprising:
means for securing said pager to a person's limb.

4. The system according to claim 1, further comprising means for pre-selecting a desired pager to operate in a predetermined mode so as to communicate between a limited number of personnel in said facility.

5. The system according to claim 1, further comprising means for backlighting a display screen on said portable pagers.

6. The system according to claim 1, wherein said monitoring stations and said pagers are programmed to send messages in predetermined languages other than a language of an inputted text.
